(19) United States
(12) Patent Application Publication
(10) Pub. No.: US 2006/0259508 A1
(43) Pub. Date: Nov. 16, 2006

(54) METHOD AND APPARATUS FOR DETECTING SEMANTIC ELEMENTS USING A PUSH DOWN AUTOMATON

(75) Inventors: Somsubhra Sikdar, Cupertino, CA (US); Kevin Jerome Rowett, Cupertino, CA (US)

Correspondence Address: MARGER JOHNSON & MCCOLLOM, P.C., 210 SW MORRISON STREET, SUITE 400, PORTLAND, OR, 97204, US

(73) Assignee: MISTLETOE TECHNOLOGIES, INC., Cupertino, CA (US)

(21) Appl. No.: 11/458,544

(22) Filed: Jul. 19, 2006

Related U.S. Application Data
(63) Continuation-in-part of application No. 10/351,030, filed on Jan. 24, 2003.
(60) Provisional application No. 60/701,748, filed on Jul. 22, 2005.

(51) Int. Cl. G06F 7/00

(52) U.S. Cl. 707/102

(57) ABSTRACT

A computer architecture uses a PushDown Automaton (PDA) and a Context Free Grammar (CFG) to process data. A PDA engine maintains semantic states that correspond to semantic elements in an input data set. The PDA engine does not have to maintain a new state for each new character in a target search string and typically only transitions to a new state when the entire semantic element is detected. The PDA engine can therefore use a smaller and more predictable state table than DFA algorithms. Transitions between the semantic states are managed using a stack that allows multiple semantic states to be represented by a single nested non-terminal symbol.

This application claims priority to U.S. Provisional Patent Application No. 60/701,748. filed Jul. 22, 2005; and is a continuation-in-part of copending, commonly-assigned U.S. patent application Ser. No. 10/351,030, filed on Jan. 24, 2003, which is herein incorporated by reference in its entirety.

### BACKGROUND

Regular expressions are patterns of characters that are used for matching sequences of characters in text. For example, regular expressions can be used to test whether a sequence of characters has an allowed pattern corresponding to a credit card number or a Social Security number. Regular expressions (abbreviated as regexp, regex, or regxp) are used by many text editors and utilities to search and manipulate bodies of text based on certain patterns. Many programming languages support regular expressions for string manipulation. For example, Perl has a regular expression engine built directly into its syntax. The set of utilities provided by Unix were the first to popularize the concept of regular expressions.

A regular expression defining a regular language is compiled into a recognizer by constructing a generalized transition diagram call a finite automation. The finite automaton is a method of algorithmically recognizing the patterns specified by the regular expression. A finite automation can be deterministic or nondeterministic, where “nondeterministic” means that more than one transition out of a state may be possible on the same input symbol.

Both Deterministic Finite Automata (DFA) and Nondeterministic Finite Automata (NDFA) are capable of recognizing precisely the regular sets. Thus finite automata can recognize exactly what the regular expression denotes. However, there is a time-space tradeoff; while deterministic finite automata can lead to faster recognizers than non-deterministic automata, a deterministic finite automata can be much more complex than an equivalent nondeterministic automata. Some classes of regular expressions can only be described by automata that grow exponentially in size, while the required regular expression only grows linearly.

Thus, current computer architectures have only a limited ability to execute DFAs. This is primarily due to the large number of states that have to be maintained. For each state, the computer has to execute more instructions and manage more state variables and data located either in registers or in a main memory. Further, the highly complex inter-relationship between the different states, often make it difficult to modify an existing DFA algorithm with new search criteria.

FIG. 1 shows one example of a relatively simple DFA algorithm 12 used for searching input data 14 for a Uniform Resource Locator (URL) 16. In this example, the DFA 12 is used for identifying a URL string “WWW.XXX.ORG”, where the symbol “X” represents a “don't care” condition. An initial first state S₀ searches input data 14 for a first W character. When a first W character is found, the DFA 12 moves to a second state S₁ where the input data 14 is searched for a second contiguous W character. If the first detected W character is not immediately followed by another W character, the DFA 12 moves from state S₁ back to S₀.

If two back-to-back W characters are detected, the DFA 12 moves to state S₂. The processor implementing DFA 12 moves into state S₃ when three contiguous W characters are detected and moves to state S₄ when three contiguous back-to-back W's are immediately followed by a period “.” character.

Notice that in this example, a branch occurs at state S₄. When the character string “WWW.” is detected, the processor in states S₉, S₁₀, S₁₁, and S₁₂ search for the second piece of the URL containing the extension “.ORG”. However, the processor might need to also determine if another “WWW.” sting occurs while searching for “.ORG”. For example, the first detected “WWW.” character string may have been used in text that is not associated with the URL “WWW.XXX.ORG”. Therefore, a separate set of states S₅, S₆, and S₇ have to be maintained in the DFA 12 for the possibility that the input data 14 may contain a character sequence such as: “WWW.XXXXXXWWW.XXX.ORG”.

FIG. 2 shows a DFA state table 22 that identifies the state transitions shown in FIG. 1. Individual input characters 18 from the input data 14 in FIG. 1 determine how transitions are made between different states 20 in the state table 22. For example, the state table 22 may initially be in state S₀. When a W character is received at input 18, the state table 22 transitions from state S₀ to state S₁. When a second W character is received at input 18 while in state S₁, the state table 22 transitions to state S₃, etc. A state vector 24 is output by state table 22 that identifies the state of the DFA search after receiving the latest input character 18.

FIG. 3 shows a DFA search engine 30 that uses the state table 22 described in FIG. 2. The state table 22 is programmed into a Programmable Logic Device (PLD) 26. The PLD 26 receives the sequence of input characters 18 and outputs the state vector 24. The state vector 24 is stored in a buffer 29 and then fed back into the state table 22 along with a next input character 18. The input characters 18 are fed into the PLD 26 one character at a time until the state table 22 transitions into state S12 indicating the URL string WWW.XXX.ORG has been detected (see FIG. 1). The DFA engine 30 generates an output 31 when state S₁₂ is detected notifying another processing element that the URL string has been detected.

The Problems With Deterministic and Non-Deterministic Finite Automaton Algorithms Additional character string matches, longer character string matches, and branch operations all substantially increase the number of states that have to be maintained in DFA engine 30. For example, the number of input characters 18 fed into PLD 26 may be J bits wide and the state vector 24 output by the PLD 26 may be K bits wide. While different algorithms are used to minimize the complexity of state table 22, the size of the logic array used in PLD 26 may still be: state table size=2^{(J+K)}.

The physical size limitation of PLD 26 restrict the DFA engine 30 to relatively low-complexity character string searches. The PLD 26 is predictable as long as the state table 22 does not exceed the capacity of PLD 26. However, the number of DFA states in the DFA engine 30 continues to increase for each additional character added to the search string. Thus, adding just one additional search string, or search character, to the DFA algorithm can possibly exceed the capacity of PLD 26.

For example, the character string “WWWW.XXX.ORG” might need to be searched instead of the search string WWW.XXX.ORG previously shown in FIG. 1. This new search string only adds one additional character “W” to the earlier URL search string. However, the new search string requires adding multiple additional states to state table 22. Branches in the DFA algorithm 12 in FIG. 1 further complicate the state table 22. This is illustrated by states S₅, S₆, and S₇ in FIG. 1 that also need to be modified to detect an additional “W” character.

It is also difficult to reconfigure the DFA engine 30 for new character searches. Even if additional characters are not added, changing just one character in search string may require reconfiguration of the entire DFA state table 22. For example, changing the desired search string from “WWW.XXX.ORG” to “WOW.XXX.ORG” may change many of the state transitions in state table 22. This is further complicated by any state optimizations or minimizations that are performed to reduce the overall size of DFA state table 22. As a result, the size and operation of the DFA engine 30 can be unpredictable.

Current search techniques, including the regular expression implementation in the Lennox® operating system, are based on DFA algorithms. The DFA algorithm may be simulated in software where that the entire state table 22 is stored in memory. Other systems implement the DFA state table 22 using a programmable hardware device, such as the PLD 26 shown in FIG. 3. Regardless, both implementations have the same problem where any additions or changes to search criteria can explode the size of the corresponding DFA state table and thereby exceed the capacity of the system implementing a DFA algorithm.

The present invention addresses this and other problems associated with the prior art.

### SUMMARY OF THE INVENTION

A computer architecture uses a PushDown Automaton (PDA) and a Context Free Grammar (CFG) to process data. A PDA engine maintains semantic states that correspond to semantic elements in an input data set. The PDA engine does not have to maintain a new state for each new character in a target search string and typically only transitions to a new state when the entire semantic element is detected. The PDA engine can therefore use a smaller and more predictable state table than DFA algorithms. Transitions between the semantic states are managed using a stack that allows multiple semantic states to be represented by a single nested non-terminal symbol.

The foregoing and other objects, features and advantages of the invention will become more readily apparent from the following detailed description of a preferred embodiment of the invention which proceeds with reference to the accompanying drawings.

### BRIEF DESCRIPTION OF THE DRAWINGS

FIG. 1 is a state diagram showing how a Uniform Resource Locator (URL) search is performed using a Deterministic Finite Automaton (DFA).

FIG. 2 is a state table for the DFA implemented URL search shown in FIG. 1.

FIG. 3 is a DFA engine that implements the DFA URL search shown in FIGS. 1 and 2.

FIG. 4 shows a PushDown Automaton (PDA) engine.

FIG. 5 is a semantic state diagram showing how the PDA engine in FIG. 4 conducts a URL search in fewer states than the DFA engine shown in FIG. 3

FIG. 6 is a semantic state diagram showing how the PDA engine uses the same number of semantic states for searching a longer character string.

FIG. 7 shows how the PDA engine only uses one additional semantic state to search for an additional semantic element.

FIGS. 8-12 are detailed diagrams showing how the PDA engine conducts an example URL search.

FIG. 13 shows how the PDA engine is implemented in a Reconfigurable Semantic Processor (RSP).

### DETAILED DESCRIPTION

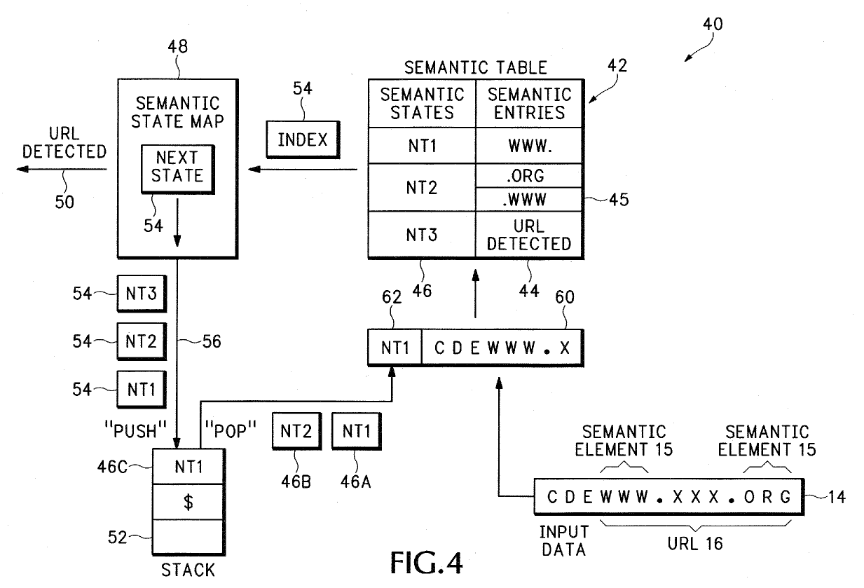

FIG. 4 shows one example of a PushDown Automaton (PDA) engine 40 that uses a Context Free Grammar (CFG) to more effectively search data. A semantic table 42 includes Non-Terminal (NT) symbols 46 that represent different semantic states managed by the PDA engine 40. Each semantic state 46 also has one or more corresponding semantic entries 44 that are associated with semantic elements 15 contained in input data 14. Arbitrary portions 60 of the input data 14 are combined with a current non-terminal symbol 62 and applied to the entries in semantic table 42.

An index 54 is output by semantic table 42 that corresponds to an entry 46,44 that matches the combined symbol 62 and input data segment 60. A semantic state map 48 identifies a next non-terminal symbol 54 that represents a next semantic state for the PDA engine 40. The next non-terminal symbol 54 is pushed onto a stack 52 and then popped from the stack 52 for combining with a next segment 60 of the input data 14. The PDA engine 40 continues parsing through the input data 14 until the target search string 16 is detected.

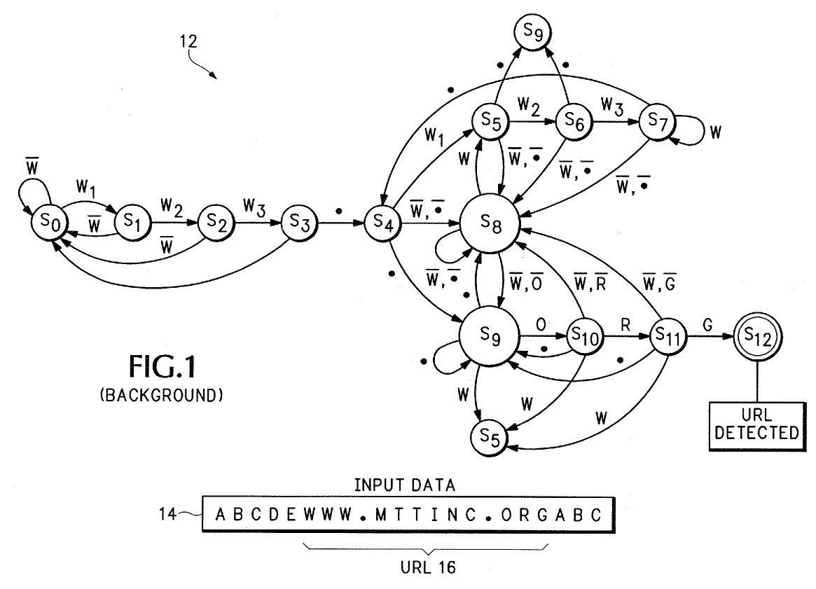

The PDA engine 40 shown in FIG. 4 operates differently than the DFA algorithm 12, state table 22, and DFA engine 30 shown in FIGS. 1-3. First, the stack 52 can contain terminal and non-terminal (NT) symbols that allow the semantic states for the PDA engine 40 to be nested inside other semantic states. This allows multiple semantic states to be represented by a single non-terminal symbol and requires a substantially smaller number of states to be managed by the PDA engine 40.

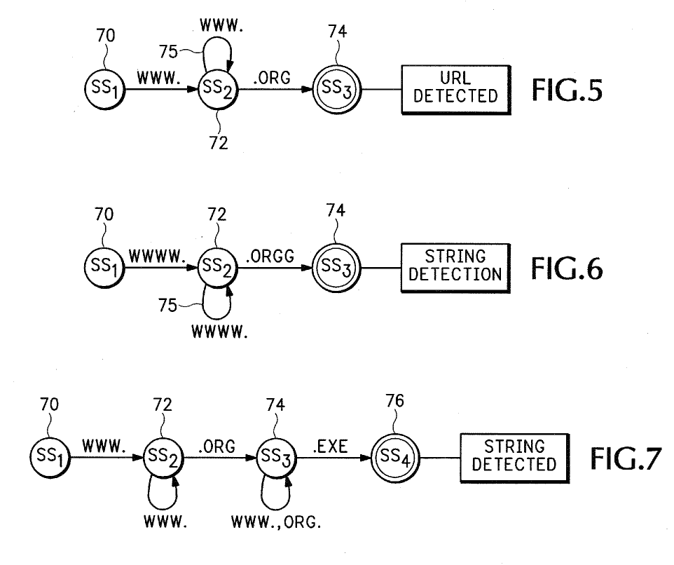

Further, referring to FIGS. 4 and 5, there are usually no semantic state transitions until an associated semantic element is detected. For example, the PDA engine 40 initially operates in a first Semantic State (SS) 70 and does not transition into a second semantic state 72 until the entire semantic element “WWW.” is detected. Similarly, the PDA engine 40 remains in semantic state 72 until the next semantic element “.ORG” is detected. One then does the PDA engine 40 transition from semantic state 72 to semantic state 74. Thus, one characteristic of the PDA engine 40 is that the number of semantic states 70, 72, and 74 correspond to the number of semantic elements that need to be searched in the input data 14.

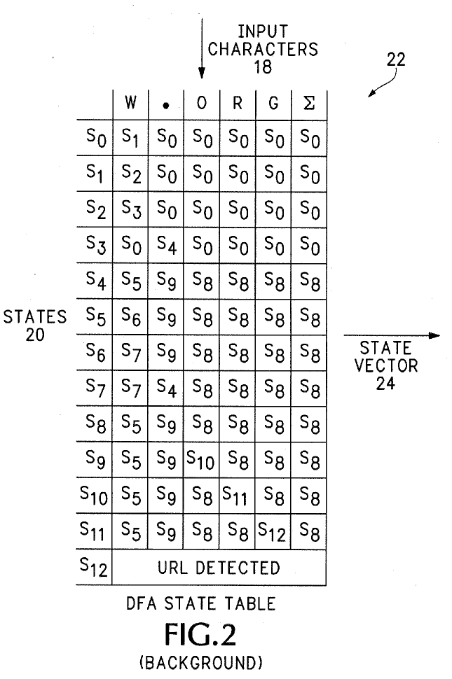

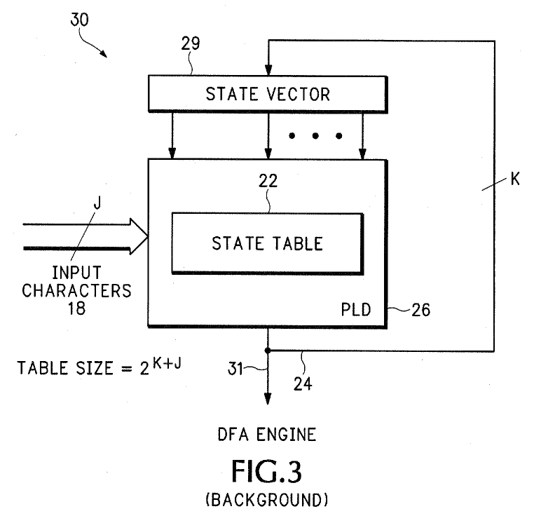

This is different than DFA algorithms that maintain states for each indiscriminate bit or byte that comprises a piece of the semantic element. For example, referring back to FIG. 2, each state 20 in state table 22 corresponds to an individual input character W “.” 0, R, G, or other character (Σ). Thus, the DFA engine 30 (FIG. 3) must maintain a larger number of states 20 for longer character search strings.

Conversely, the PDA engine 40 in FIG. 4 may not require any additional semantic states to search for longer character strings. For example, FIG. 6 shows an alternative search that requires the PDA engine 40 to search for the string “WWWW.XXXX.ORGG”. In this example, the PDA engine 40 is required to search for an additional “W” in the first semantic element “WWWW.” and search for an additional “G” character in the second semantic element “ORGG”. The additional characters added to the new search sting in FIG. 6 does not increase the number of semantic states 70, 71, and 73 previously required in FIG. 5.

Conversely, the DFA state table 22 in FIG. 2 would require additional states to detect the additional “W” character in the first string set “WWWW.”, additional states to detect the possible occurrence of a second “WWWW.” string, and still additional states to detect the additional “G” character in the second string set “.ORGG”.

The PDA engine 40 can also reduce or eliminate state branching. For example, as described above in FIG. 1, the URL search performed using the DFA algorithm 12 requires a separate branch to determine a possible second occurrence of “WWW.”, after a first “WWW.” string is detected. This requires a separate set of states S₅, S₆, and S₇.

The PDA engine 40 eliminates these additional branching states by nesting the possibility of a second “WWW.” string into the same semantic state 72 that searches for the “.ORG” semantic element. This is represented by path 75 in FIG. 5 where the PDA engine 40 remains in semantic state 72 while searching for a second possible occurrence of “WWW.” and for “.ORG”.

Another aspect of the PDA engine 40 is that additional search strings can be added without substantially impacting or adding to the complexity of the semantic table 42. Referring to FIG. 7, a third semantic element “.EXE” is shown added to the search performed by the PDA engine 40 in FIG. 4. The addition semantic element “.EXE” adds only one additional semantic state 76 to the semantic table 42. Conversely, the additional search string “.EXE” adds numerous additional states to the DFA state table 22 in FIG. 2 while also impacting the values for many of the existing states.

Thus, the PDA architecture in FIG. 4 results in more compact and efficient state tables that have more predictable and stable linear state expansion when adding additional search criteria. For example, when a new string is added to a data search, the entire semantic table 42 does not need to be rewritten and only requires incremental additional semantic entries.

Example Implementation

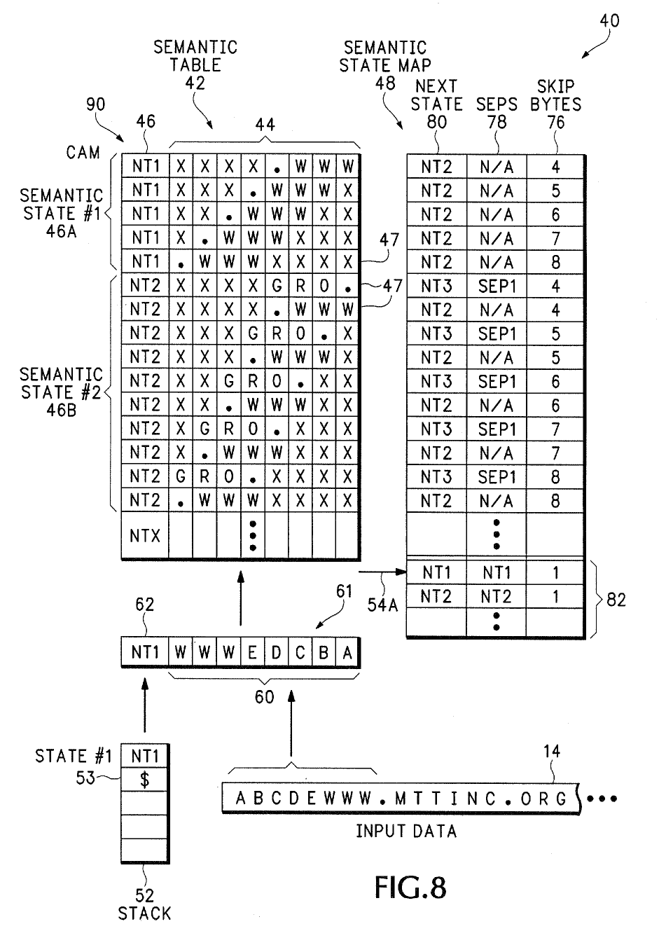

FIGS. 8-12 show in more detail an example PDA context free grammar executed by the PDA engine 40 previously shown in FIG. 4. Referring first to FIG. 8, the same search example is used where the PDA engine 40 searches for the URL string “WWW.XXX.ORG”. Of course this is only one example, and any string or combination of characters can be searched using PDA engine 40.

It should also be noted that the PDA engine 40 can also be implemented in software so that the semantic table 42, semantic state map 48, and stack 52 are all locations in a memory accessed by a Central Processing Unit (CPU). The general purpose CPU then implements the operations described below. Another implementation uses a Reconfigurable Semantic Processor (RSP) that is described in more detail below in FIG. 5.

In this example, a Content Addressable Memory (CAM) is used to implement the semantic table 42. Alternative embodiments may use an Static Random Access Memory (SRAM) or Dynamic Random Access Memory (DRAM). The semantic table 42 is divided up into semantic state sections 46 that, as described above, may contain a corresponding non-terminal (NT) symbol. In this example, the semantic table 42 contains only two semantic states. A first semantic state in section 46A is identified by non-terminal NT1 and associated with the semantic element “WWW.”. A second semantic state in section 46B is identified by non-terminal NT2 and associated with the semantic element “.ORG”.

A second section 44 of semantic table 42 contains different semantic entries corresponding to semantic elements in input data 14. The same semantic entry can exist multiple times in the same semantic state section 46. For example, the semantic entry WWW. can be located in different positions in section 46A to identify different locations where the semantic element “WWW.” may appear in the input data 14. This is only one example, and is used to further optimize the operation of the PDA engine 40. In an alternative embodiment, only a particular semantic entry may only be used once and the input data 14 sequentially shifted into input buffer 61 to check each different data position.

The second semantic state section 46B in semantic table 42 effectively includes two semantic entries. A “.ORG” entry is used to detect the “.ORG” string in the input data 14 and a “WWW.” entry is used to detect a possible second “WWW.” string in the input data 14. Again, multiple different “.ORG” and “WWW.” entries are optionally loaded into section 46B of semantic table 42 for parsing optimization. It is equally possible to use one “WWW.” entry and one “ORG.” entry, or fewer entries than shown in FIG. 8.

The semantic state map 48, in this example, contains three different sections. However, fewer sections may also be used. A next state section 80 maps a matching semantic entry in semantic table 42 to a next semantic state used by the PDA engine 40. A Semantic Entry Point (SEP) section 78 is used to launch microinstructions for a Semantic Processing Unit (SPU) that will be described in more detail below. This section is optional and PDA engine 40 may alternatively use the non-tenninal symbol identified in next state section 80 to determine other operations to perform next on the input data 14.

For example, when the non-terminal symbol NT3 is output from map 48, a corresponding processor (not shown) knows that the URL string “WWW.XXX.ORG” has been detected in input data 14. The processor may then conduct whatever subsequent processing is required on the input data 14 after PDA engine 40 identifies the URL. Thus, the SEP section 78 is just one optimization in the PDA engine 40 that may or may not be included.

A skip bytes section 76 identifies the number of bytes from input data 14 to shift into input buffer 61 in a next operation cycle. A Match All Parser entries Table (MAPT) 82 is used when there is no match in semantic table 42.

Execution

A special end of operation symbol “$” is first pushed onto stack 52 along with the initial non-terminal symbol NT1 representing a first semantic state associated with searching for the URL. The NT1 symbol and a first segment 60 of the input data 14 are loaded into input buffer 61 and applied to CAM 90. In this example, the contents in input buffer 61 do not match any entries in CAM 90. Accordingly, the pointer 54 generated by CAM 90 points to a default NT1 entry in MAPT table 82. The default NT1 entry directs the PDA engine 40 to shift one additional byte of input data 14 into input buffer 61. The PDA engine 40 then pushes another non-terminal NT1 symbol onto stack 52

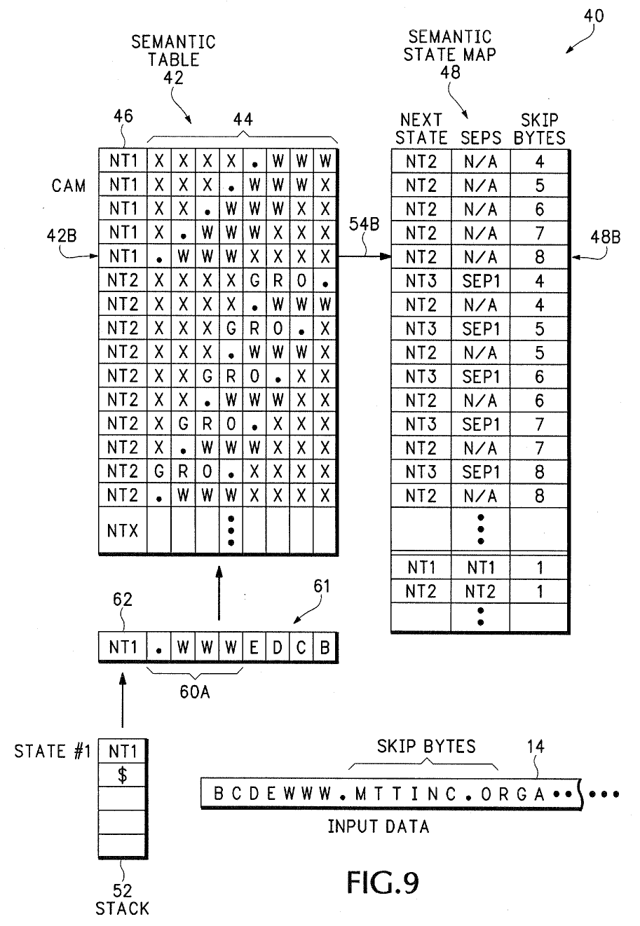

FIG. 9 shows the next PDA cycle after the next byte of input data 14 is shifted into input buffer 61. The first URL element 60A (“WWW.”) is now contained in the input buffer 61. The non-terminal symbol NT1 is again popped from the stack 52 and combined with input data 60 in input buffer 61. The comparison of input buffer 61 with the contents in semantic table 42 results in a match at NT1 entry 42B. The index 54B associated with table entry 42B points to semantic state map entry 48B. The next state in entry 48B contains non-terminal symbol NT2 indicating transition to a next semantic state.

Map entry 48B also identifies the number of bytes that the PDA engine 40 needs to shift the input data 14 for the next parsing cycle. In this example, since the “WWW.” string was detected in the first four bytes of the input buffer 61, the skip bytes value in entry 48B directs the PDA engine 40 to shift another 8 bytes into the input buffer 61. The skip value is hardware dependant, and can vary according to the size of the semantic table 42. Of course other hardware implementations can also be used that have larger or smaller semantic table widths.

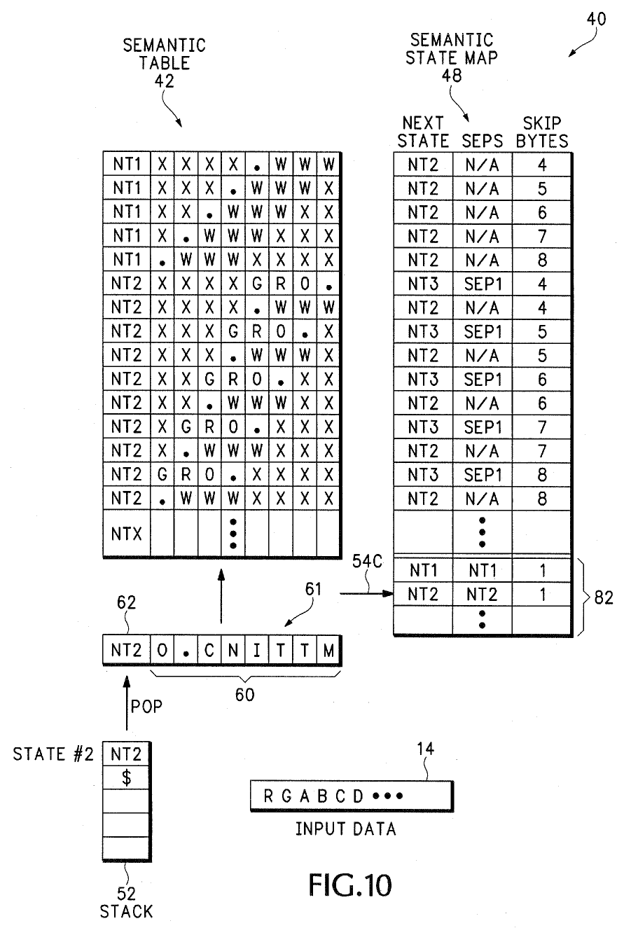

FIG. 10 shows the next cycle in the PDA engine 40 after the next 8 bytes of the input data 14 have been shifted into input buffer 61. Also, the new semantic state NT2 has been pushed onto stack 52 and then popped off of stack 52 and combined with the next segment 60 of the input data 14. The contents in input buffer 61 are again applied to the semantic table 42. In this PDA cycle, the contents in input buffer 61 do not match any semantic entries in semantic table 42. Accordingly, a default pointer 54C for the NT2 state points to a corresponding NT2 entry in MAPT table 82. The NT2 entry directs the PDA engine 40 to shift one additional byte into the input buffer 61 and push the same semantic state NT2 onto stack 52.

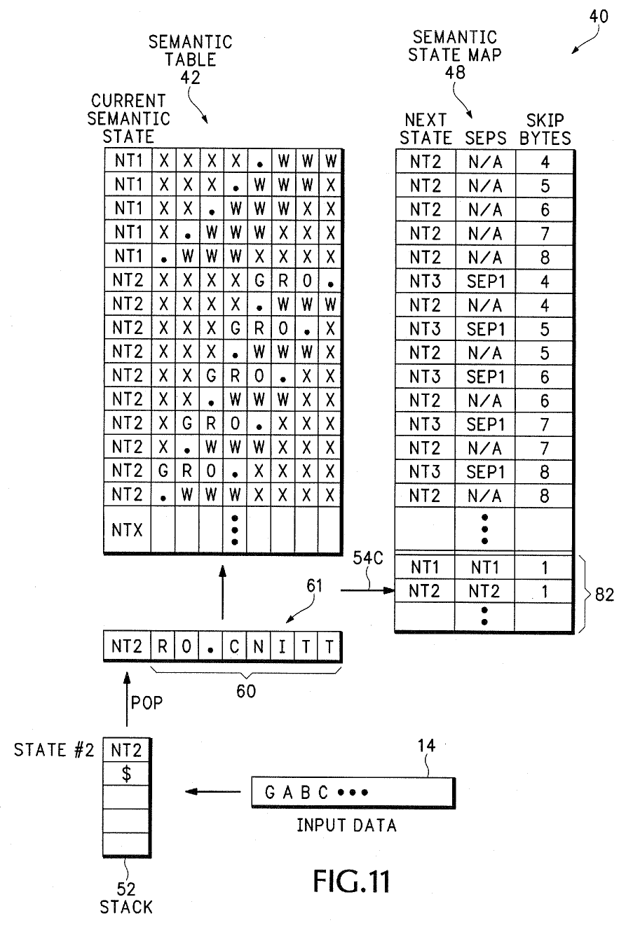

FIG. 11 shows a next PDA cycle after another byte of input data 14 has been shifted into the input buffer 61. In this example, there still is no match between the contents in input buffer 61 and any of the NT2 entries in semantic table 42. Accordingly, the default pointer 54C for semantic state NT2 points again to the NT2 entry in MAPT table 82. The default NT2 entry in table 82 directs the PDA engine 40 to shift another byte from input data 14 into the input buffer 61 and push another NT2 symbol onto the stack 52.

Note that during the last two PDA cycles there was no change in the semantic state represented by non-terminal NT2. There was no state transition even though the first three characters “.OR” in the second semantic element “.ORG” were received by the PDA engine 40. This is contrary to the DFA engine 30 shown in FIG. 3 where each sub-character in the semantic element “.ORG” would have caused a transition to another DFA state. For example, see states S₉, S₁₀, S₁₁, and S₁₂ in FIG. 1.

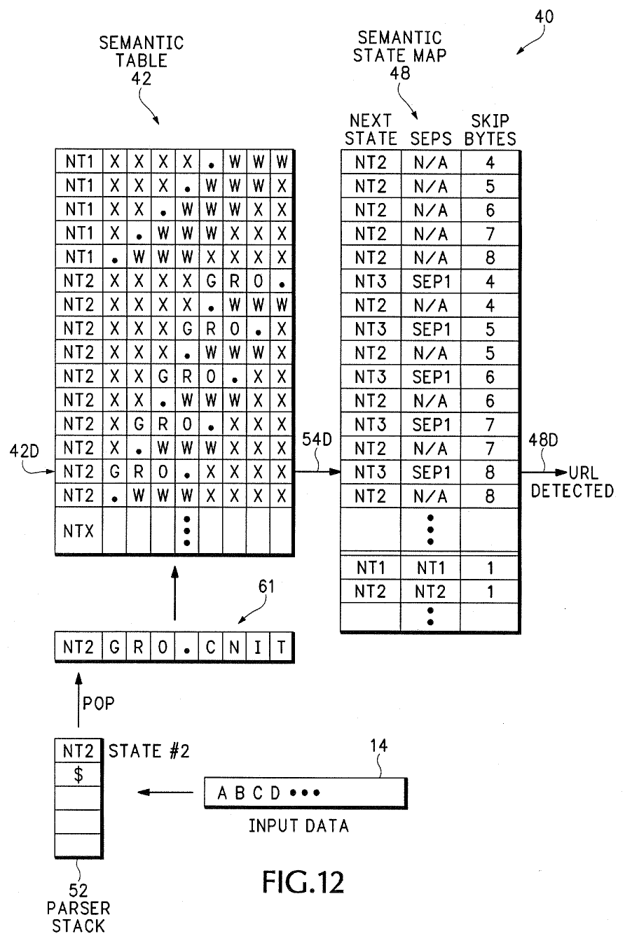

FIG. 12 shows the next PDA cycle where the contents in input buffer 61 now match NT2 entry 42D in the semantic table 42. The corresponding pointer 54D points to entry 48D in the semantic state map 48. In this example, entry 48D indicates the URL “WWW.XXX.ORG” has been detected by mapping to a next semantic state NT3. Notice that the PDA engine 40 did not transition into semantic state NT3 until the entire semantic element “.ORG” was detected.

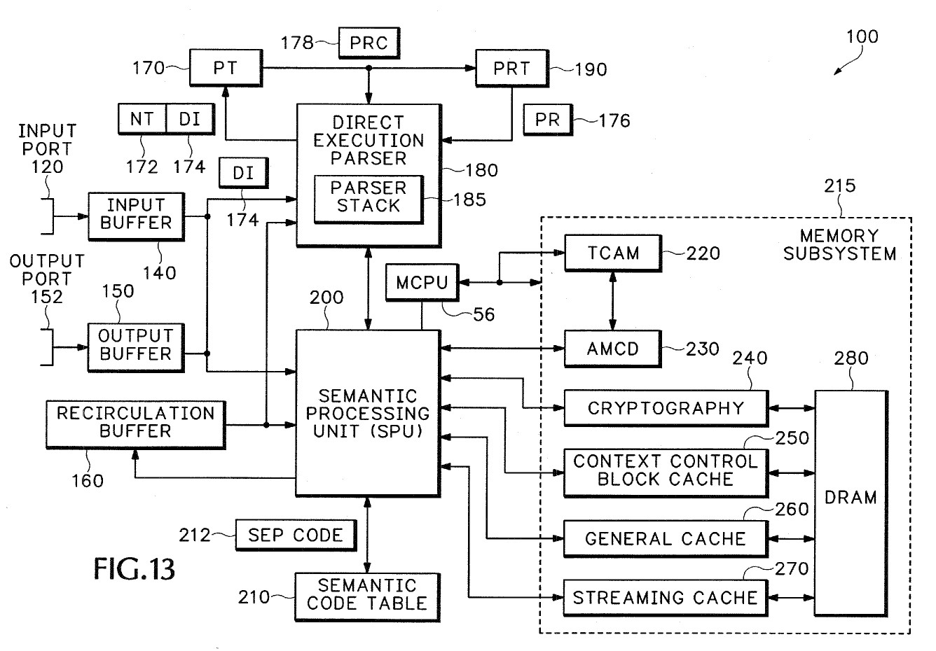

Map entry 48D also includes a pointer SEP1 that optionally launches microinstructions are executed by a Semantic Processing Unit (SPU) (see FIG. 13) for performing additional operations on the input data 14 corresponding to the detected URL. For example, the SPU may peel off additional input data 14 that for performing a firewall operation, virus detection operation, etc. as described in co-pending applications entitled: NETWORK INTERFACE AND FIREWALL DEVICE, Ser. No. 11/187,049, filed Jul. 21, 2005; and INTRUSION DETECTION SYSTEM, Ser. No. 11/125,956, filed May 9, 2005, which are both herein incorporated by reference.

Concurrently with the launching of the SEP micro-instructions for the SPU, the map entry 48D may also direct the PDA engine 40 to push the new semantic state represented by non-terminal NT3 onto stack 52. This may cause the PDA engine 40 to start conducting a different search for other semantic element in the input data 14 following the detected URL 16. For example, as shown in FIG. 7, the PDA engine 40 may start searching for the semantic element “.EXE” associated with an executable file that may be contained in the input data 14. As also described above, the search for the new semantic element “.EXE” only requires the PDA engine 40 to add one additional semantic state in semantic table 42.

Thus, the PDA engine 40 identifies the URL with substantially fewer states than the DFA engine 22 shown in FIGS. 1-3. As also described above, the PDA engine 40 is not required to maintain separate states for each parsed data item. States are only maintained for transitions between different semantic elements. For example, FIGS. 8, 10 and 11 show data inputs that did not completely match any of the semantic entries in the semantic table 42. In these situations, the PDA engine 40 continues to parse through the input data without retaining any state information for the non-matching data string.

As also previously mentioned above in FIGS, 4-6, the semantic states in the PDA engine 40 are substantially independent of search string length. For example, a longer search string “WWWW.” can be searched instead of “WWW.” simply by replacing the semantic entries “WWW.” in semantic table 42 with the longer semantic entry “WWWW.” and then accordingly adjusting the skip byte values in map 48.

Conversely, the DFA engine 30 in FIG. 3 requires a new state for each new character in the search string and possibly one or more additional branches to other groups of states. Thus, expanding the search string can create a substantial unstable increase in the number of states that have to be tracked by the PDA engine 30.

Reconfigurable Semantic Processor (RSP)

FIG. 13 shows a block diagram of a Reconfigurable Semantic Processor (RSP) 100 used in one embodiment for implementing the PushDown Automaton (PDA) engine 40 described above. The RSP 100 contains an input buffer 140 for buffering a packet data stream received through the input port 120 and an output buffer 150 for buffering the packet data stream output through output port 152.

A Direct Execution Parser (DXP) 180 implements the PDA engine 40 and controls the processing of packets or frames received at the input buffer 140 (e.g., the input “stream”), output to the output buffer 150 (e.g., the output “stream”), and re-circulated in a recirculation buffer 160 (e.g., the recirculation “stream”). The input buffer 140, output buffer 150, and recirculation buffer 160 are preferably first-in-first-out (FIFO) buffers.

The DXP 180 also controls the processing of packets by a Semantic Processing Unit (SPU) 200 that handles the transfer of data between buffers 140, 150 and 160 and a memory subsystem 215. The memory subsystem 215 stores the packets received from the input port 120 and may also store an Access Control List (ACL) in CAM 220 used for Unified Policy Management (UPM), firewall, virus detection, and any other operations described in co-pending patent applications: NETWORK INTERFACE AND FIREWALL DEVICE, Ser. No. 11/187,049, filed Jul. 21, 2005; and INTRUSION DETECTION SYSTEM, Ser. No. 11/125,956, filed May 9, 2005, which have both already been incorporated by reference.

The RSP 100 uses at least three tables to implement a given PDA algorithm. Codes 178 for retrieving production rules 176 are stored in a Parser Table (PT) 170. The parser table 170 in one embodiment is contains the semantic table 42 shown in FIG. 4. Grammatical production rules 176 are stored in a Production Rule Table (PRT) 190. The production rule table 190 may for example contain the semantic state map 48 shown in FIG. 4. Code segments 212 executed by SPU 200 are stored in a Semantic Code Table (SCT) 210. The code segments 212 may be launched according to the SEP pointers 78 in the semantic state map 48 shown in FIGS. 8-12.

Codes 178 in parser table 170 are stored, e.g., in a row-column format or a content-addressable format. In a row-column format, the rows of the parser table 170 are indexed by a non-terminal code NT 172 provided by an internal parser stack 185. The parser stack 185 in one embodiment is the stack 52 shown in FIG. 4. Columns of the parser table 170 are indexed by an input data value DI[N] 174 extracted from the head of the data in input buffer 140. In a content-addressable format, a concatenation of the non-terminal code 172 from parser stack 185 and the input data value 174 from input buffer 140 provide the input to the parser table 170 as shown by the input buffer 61 in FIGS. 8-12. The production rule table 190 is indexed by the codes 178 from parser table 170. The tables 170 and 190 can be linked such that a query to the parser table 170 will directly return a production rule 176 applicable to the non-terminal code 172 and input data value 174. The DXP 180 replaces the non-terminal code at the top of parser stack 185 with the production rule (PR) 176 returned from the PRT 190, and continues to parse data from input buffer 140.

The semantic code table 210 is also indexed according to the codes 178 generated by parser table 170, and/or according to the production rules 176 generated by production rule table 190. Generally, parsing results allow DXP 180 to detect whether, for a given production rule 176, a Semantic Entry Point (SEP) routine 212 from semantic code table 210 should be loaded and executed by SPU 200.

The SPU 200 has several access paths to memory subsystem 215 which provide a structured memory interface that is addressable by contextual symbols. Memory subsystem 215, parser table 170, production rule table 190, and semantic code table 210 may use on-chip memory, external memory devices such as synchronous Dynamic Random Access Memory (DRAM)s and Content Addressable Memory (CAM)s, or a combination of such resources. Each table or context may merely provide a contextual interface to a shared physical memory space with one or more of the other tables or contexts.

A Maintenance Central Processing Unit (MCPU) 56 is coupled between the SPU 200 and memory subsystem 215. MCPU 56 performs any desired functions for RSP 100 that can reasonably be accomplished with traditional software and hardware. These functions are usually infrequent, non-time-critical functions that do not warrant inclusion in SCT 210 due to complexity. Preferably, MCPU 56 also has the capability to request the SPU 200 to perform tasks on the MCPU's behalf.

The memory subsystem 215 contains an Array Machine-Context Data Memory (AMCD) 230 for accessing data in DRAM 280 through a hashing function or Content-Addressable Memory (CAM) lookup. A cryptography block 240 encrypts, decrypts, or authenticates data and a context control block cache 250 caches context control blocks to and from DRAM 280. A general cache 260 caches data used in basic operations and a streaming cache 270 caches data streams as they are being written to and read from DRAM 280. The context control block cache 250 is preferably a software-controlled cache, i.e. the SPU 200 determines when a cache line is used and freed. Each of the circuits 240, 250, 260 and 270 are coupled between the DRAM 280 and the SPU 200. A TCAM 220 is coupled between the AMCD 230 and the MCPU 56 and contains an Access Control List (ACL) table and other parameters that may be used for conducting firewall, unified policy management, or other intrusion detection operations.

Detailed design optimizations for the functional blocks of RSP 100 are described in co-pending application Ser. No. 10/351,030, entitled: A Reconfigurable Semantic Processor, filed Jan. 24, 2003 which is herein incorporated herein by reference.

Parser Table

As described above in FIGS. 4-12, the parser table 170 may be implemented as a Content Addressable Memory (CAM), where an NT code and input data values DI[n] are used as a key for the CAM to look up the PR code 176 corresponding to a production rule in the PRT 190. Preferably, the CAM is a Ternary CAM (TCAM) populated with TCAM entries. Each TCAM entry comprises an NT code and a DI[n] match value. Each NT code can have multiple TCAM entries. Each bit of the DI[n] match value can be set to “0”, “1”, or “X” (representing “Don't Care”). This capability allows PR codes to require that only certain bits/bytes of DI[n] match a coded pattern in order for parser table 170 to find a match. For instance, one row of the TCAM can contain an NT code NT_IP for an IP destination address field, followed by four bytes representing an IP destination address corresponding to a device incorporating semantic processor. The remaining four bytes of the TCAM row are set to “don't care.” Thus when NT_IP and eight bytes DI[8] are submitted to parser table 170, where the first four bytes of DI[8] contain the correct IP address, a match will occur no matter what the last four bytes of DI[8] contain.

Since the TCAM employs the “Don't Care” capability and there can be multiple TCAM entries for a single NT, the TCAM can find multiple matching TCAM entries for a given NT code and DI[n] match value. The TCAM prioritizes these matches through its hardware and only outputs the match of the highest priority. Further, when a NT code and a DI[n] match value are submitted to the TCAM, the TCAM attempts to match every TCAM entry with the received NT code and DI[n] match code in parallel. Thus, the TCAM has the ability to determine whether a match was found in parser table 170 in a single clock cycle of semantic processor 100.

Another way of viewing this architecture is as a “variable look-ahead” parser. Although a fixed data input segment, such as eight bytes, is applied to the TCAM, the TCAM coding allows a next production rule (or semantic entry as described in FIGS. 4-12) to be based on any portion of the current eight bytes of input. If only one bit, or byte, anywhere within the current eight bytes at the head of the input stream, is of interest for the current rule, the TCAM entry can be coded such that the rest are ignored during the match. Essentially, the current “symbol” can be defined for a given production rule as any combination of the 64 bits at the head of the input stream. By intelligent coding, the number of parsing cycles, NT codes, and table entries can generally be reduced for a given parsing task.

The TCAM implementation of the production rule table 170 is described in further detail in co-pending patent application entitled: PARSER TABLE/PRODUCTION RULE TABLE CONFIGURATION USING CAM AND SRAM, Ser. No. 11/181,527, filed Jul. 14, 2005, which is herein incorporated by reference.

The preceding embodiments are exemplary. Although the specification may refer to “an”, “one”, “another” or “some” embodiment(s) in several locations, this does not necessarily mean that each such reference is to the same embodiment(s), or that the feature only applies to a single embodiment.

The system described above can use dedicated processor systems, micro controllers, programmable logic devices, or microprocessors that perform some or all of the operations. Some of the operations described above may be implemented in software and other operations may be implemented in hardware.

For the sake of convenience, the operations are described as various interconnected functional blocks or distinct software modules. This is not necessary, however, and there may be cases where these functional blocks or modules are equivalently aggregated into a single logic device, program or operation with unclear boundaries. In any event, the functional blocks and software modules or features of the flexible interface can be implemented by themselves, or in combination with other operations in either hardware or software.

Having described and illustrated the principles of the invention in a preferred embodiment thereof, it should be apparent that the invention may be modified in arrangement and detail without departing from such principles. Claim is made to all modifications and variation coming within the spirit and scope of the following claims.

1. A PushDown Automaton (PDA) engine, comprising:
a semantic table configured into different sections corresponding to different PDA semantic states where at least some of the sections contain one or more semantic entries that correspond with multi-character semantic elements that may be contained in input data, the semantic table indexed by combining symbols identifying the different semantic states with segments of the input data.

2. The PDA engine according to claim 1 including a semantic state map that identifies a next PDA semantic state according to the semantic entry in a current PDA semantic state that matches the combined symbol and input data segment.

3. The PDA engine according to claim 2 including a stack that pops a symbol for combining with the input data segments and pushes a next symbol corresponding with the next semantic state identified by the semantic state map.

4. The PDA engine according to claim 3 wherein the stack contains non-terminal symbols that represent multiple previous PDA semantic states.

5. The PDA engine according to claim 1 wherein the semantic table transitions between different PDA semantic states according to the semantic elements identified in the input data and independently of individual characters that may be contained in the semantic elements.

6. The PDA engine according to claim 1 wherein the semantic table comprises a Content Addressable Memory (CAM), semantic entry locations in the CAM matching semantic elements in the input data used for identifying a next semantic state.

7. The PDA engine according to claim 6 including a skip data map indexed by the CAM that identifies an amount of input data to shift into the PDA engine for comparing with the semantic entries.

8. The PDA engine according to claim I including a Reconfigurable Semantic Processor (RSP) that includes one or more Semantic Processing Units (SPUs) that execute additional operations on the input data according to the semantic states identified by the semantic table.

9. The PDA engine according to claim 8 including a Semantic Entry Point (SEP) map indexed by the semantic table for launching microinstructions for execution by the one or more SPUs.

10. A method for processing data, comprising:
maintaining semantic states in a search engine where at least some of the semantic states correspond with multi-character semantic elements in the data; and
transitioning between the semantic states when the entirety of the semantic elements are identified in the data while maintaining a same current semantic state as individual characters in the data that are either part of the semantic elements or unrelated to the semantic elements are parsed by the search engine.

11. The method according to claim 10 including identifying the semantic states in the search engine using non-terminal values and identifying the semantic elements in the data by combining segments of the data with the non-terminal values into an input value and comparing the input value with semantic entries in a Content Addressable Memory (CAM).

12. The method according to claim 11 wherein the indexed location in the map table identifies both a next semantic state for the search engine and an amount of data to be shifted into the search engine for comparing with the semantic entries in the CAM.

13. The method according to claim 12 including shifting a default amount of the data into the search engine and remaining in a same semantic state when the input value does not match any entries in the CAM.

14. The method according to claim 11 including pushing a next non-terminal value representing a next semantic state onto a stack and pushing a current non-terminal value representing a current semantic state off the stack for combining with a next segment of the data.

15. The method according to claim 11 including using a CAM output as an index a location in a map table that identifies a next semantic state for the search engine.

16. The method according to claim 15 including identifying Semantic Entry Points (SEPs) in the map table that launch microinstructions for executing operations on the data according to the identified next semantic state.

17. The method according to claim 11 including organizing the CAM into multiple semantic state sections that each include one or more multi-character semantic entries that correspond to different multi-character semantic elements the search engine may need to identify while in the same semantic state.

18. The method according to claim 17 wherein the semantic entries include multiple characters that individually do not cause semantic state transitions in the search engine but in combination cause the search engine to transition to another semantic state.

19. The method according to claim 18 including using the search engine to identify different semantic elements in Internet packets.

20. A semantic processor, comprising:
a parser table populated with semantic entries that correspond to semantic elements in a data stream; and
a production rule table identifying production rules corresponding to the semantic entries in the parser table that match segments of the data stream, the identified production rules indicating how the semantic processor further parses the data stream.

21. The semantic processor according to claim 20 wherein the parser table indexes a production rule corresponding to semantic entries matching segments of the data stream.

22. The semantic processor according to claim 20 wherein the parser table includes a Content-Addressable Memory (CAM) that stores the semantic entries according to semantic states that are associated with a particular order of identified semantic elements in the data stream.

23. The semantic processor according to claim 22 wherein the semantic states are identified by non-terminal symbols that are combined with the segments of the data stream and used as an input to the CAM.

24. The semantic processor according to claim 23 wherein a matching entry in the CAM indexes a production rule in the production rule table that indicates a next semantic state for the semantic processor.

25. The semantic processor according to claim 24 wherein a non-terminal symbol for a current semantic state is popped off of a parser stack for combining with one of the segments of the data stream and a non-terminal symbol for a next semantic state identified in the production rule table is pushed onto the parser stack.

26. The semantic processor according to claim 25 wherein the production rule table includes skip entries that indicate what segments of the data stream are combined with the non-terminal symbol popped off the parser stack.

27. The semantic processor according to claim 20 including semantic entry point fields in the production rule table that launch micro-instructions used by a Semantic Processing Unit to further process the data stream according to the current semantic state.

28. The semantic processor according to claim 20 wherein the semantic processor remains in a same semantic state while parsing individual characters that are either a subpart of a semantic element in the data stream or are not part of a semantic element in the data stream, and the semantic processor only transitioning to other semantic states when an entire semantic element is detected in the data stream.

29. The semantic processor according to claim 28 wherein the parser table contains multiple multi-character semantic entries that are compared with multiple characters from the data stream at the same time.

30. The semantic processor according to claim 29 wherein the same parser table contains the same semantic entries for the same semantic states to compare with different byte positions in the data stream segments.
